(19) United States
(12) Patent Application Publication
(10) Pub. No.: US 2010/0208964 A1
(43) Pub. Date: Aug. 19, 2010

(54) METHOD FOR ELIMINATING SCATTER ARTEFACTS

(75) Inventors: Jens Wiegert, Aachen (DE); Matthias Bertram, Bertram (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/666,820

(22) PCT Filed: Jun. 23, 2008
(86) PCT No.: PCT/IB2008/052482

§ 371 Date: Dec. 28, 2009

(30) Foreign Application Priority Data
Jun. 29, 2007 (EP) 07111420.1

(51) Int. Cl. G06K 9/00

(52) U.S. Cl. 382/131

(57) ABSTRACT

A method, a computer program as well as a corresponding apparatus for eliminating scatter artefacts that corrupt an image of an object using computed tomography, wherein X-ray projections of the object are at least partially truncated, whereas the method comprises the steps of: reconstructing a truncated image of the object with a limited field of view from the projections; constructing a model of the object in an extended field of view using the truncated image of the object; deriving a scatter estimate by means of Monte-Carlo simulation using the model of object; correcting a projection of the object for X-ray scatter based on the scatter estimate; reconstructing a scatter-corrected image using the corrected projections.

### FIELD OF THE INVENTION

The present invention relates to a method and a corresponding apparatus for eliminating scatter artefacts that corrupt an image of an object using computed tomography. Finally, the invention relates to a computer program for implementing the methods on a computer.

### BACKGROUND OF THE INVENTION

The document WO 2006/082557 shows a model estimation unit for estimating model parameters of an object model for the object by an iterative optimization of a deviation of forward projections, calculated by use of the object model and the geometry parameters for X-ray projections from the corresponding X-ray projections as well as a scatter estimation unit for estimating the amount of scatter present in said x-ray projections by use of said object model.

Scattered radiation is a major source of image degradation and non-linearity in cone-beam computed tomography. This especially applies for system geometries with large cone angle and therefore a large irradiated area, such as for C-arm based volume imaging, where scattered radiation produces a significant, spatially slowly varying background that is added to the detected signal. As a consequence, reconstructed volumes suffer from cupping and streak artefacts due to scatter, impeding the reporting of absolute Hounsfield units.

Anti-scatter-grids composed of lead lamellae and interspacing material have shown to be ineffective for typical volume imaging geometries, because they increase the SNR ratio. Additionally, even behind the grid, a large fraction of the scattered radiation is still present and therefore anti-scatter-grids are not well suited as the only means to reduce cupping and streak artefacts. Therefore, accurate computerized scatter correction methods are inevitable in order to achieve homogeneous, artefact-free and accurately reconstructed volumes with C-arm based X-ray systems. Since CT scanners also tend towards larger cone-beam angles, more advanced scatter correction schemes may become important for CT, too.

As the requirement to accurate soft tissue delineation and the demands for obtaining a true absolute Hounsfield scale (e.g. for quantitative imaging techniques) are constantly rising, also the requirements for accurate scatter compensation is increasing.

For instance use of Monte Carlo simulations is a technique in order to study the complex distributions of scattered radiation in diagnostic radiology. Advances in computer power have recently also allowed to perform Monte Carlo simulations with voxelized object models obtained from reconstructed CT images for the purpose of scatter correction.

Since the CT images provide very detailed information about the object geometry and since the physical processes of scattering can be modelled with great accuracy, scatter distributions obtained with this technique are also very accurate and can outperform most of the available scatter estimation schemes in terms of accuracy. Furthermore, the perspective to perform Monte Carlo simulations on graphics hardware offers the potential for large speedup of the computation times. Further speedup can be achieved by dedicated calculation techniques for single scatter.

However, in case of laterally truncated projections, the above-described technique faces large problems. Especially the reconstructable field of view covers only a fraction of the total object region and therefore the Monte Carlo simulations lack important information required to compute meaningful scatter distributions.

### SUMMARY OF THE INVENTION

It is therefore an object of the present invention to provide a method and an apparatus as well as a corresponding computer program for eliminating scatter artefacts that corrupt an image of an object.

The object is achieved according to the present invention by a method for eliminating scatter artefacts that corrupt an image of an object using computed tomography, wherein X-ray projections of the object are at least partially truncated, comprising the steps of:

reconstructing a truncated image of the object with a limited field of view from the projections;
constructing a model of the object in an extended field of view using the truncated image of the object;
deriving a scatter estimate by means of Monte-Carlo simulation using the model of object;
correcting a projection of the object for X-ray scatter based on the scatter estimate;
reconstructing a scatter-corrected image using the corrected projections.

According to an exemplary embodiment, the object is achieved according to the present invention by a method whereas the model of the object is constructed by:

calculating a forward projection of the truncated image of the object according to the geometry of a measured projection;

calculating the difference between the forward projection of the truncated image of the object and the measured projection;

extending the truncated image of the object along each x-ray in two portions prior and after the limited field of view with a material accounting for the difference.

According to another exemplary embodiment the truncated image is extended along each x-ray symmetrically prior and after the limited field of view.

It is believed to be advantageously that the material is equivalent or similar to water.

Further alternatively the object is achieved according to the present invention by a method, whereas the truncated image of the object is extended in such a way that the barycenter of a x-ray attenuation line integral through the model of the object is the same as in a corresponding x-ray attenuation line integral through another model of the object.

According to another exemplary embodiment there is provided a method, whereas the barycenter is calculated by extrapolation, especially using polynomial extrapolation.

According to another exemplary embodiment the parameters of the model of the object are iteratively determined using a cost function reflecting the similarity of the measured projection data and the virtual projection data of the model of the object.

According to another embodiment of the present invention the model of the object is constructed by using further data of the object.

According to another exemplary embodiment the data is registered to the truncated image of the object.

Further alternatively the object of the present invention is achieved by a method, wherein the data is an image from another CT scan.

The object is also achieved according to the present invention by a computer program comprising program code means for causing a computer to carry out the steps of the method according to claims 1 to 10 when the computer program is executed on a computer.

The object is also achieved according to the present invention by an apparatus for eliminating scatter artefacts that corrupt an image of an object using computed tomography, wherein X-ray projections of the object are at least partially truncated, comprising:

a reconstructor for reconstructing a truncated image of the object with a limited field of view from the projections;
a constructor for constructing a model of the object in an extended field of view using the truncated image of the object;
a deriver for deriving a scatter estimate by means of Monte-Carlo simulation using the model of object;
a corrector for correcting a projection of the object for X-ray scatter based on the scatter estimate;
a reconstructor for reconstructing a scatter-corrected image using the corrected projections.

It is believed to be advantageously that the apparatus according to the present invention is adapted to construct the model of the object by:

a calculator for calculating a forward projection of the truncated image of the object according to the geometry of a measured projection;

a calculator for calculating the difference between the forward projection of the truncated image of the object and the measured projection;

an extender for extending the truncated image of the object along each x-ray in two portions prior and after the limited field of view with a material accounting for the difference.

According to the present invention the apparatus is adapted to extend the truncated image along each x-ray symmetrically prior and after the limited field of view.

According to another exemplary embodiment the material is equivalent or similar to water.

According to a further embodiment of the present invention the apparatus comprises: an extender, which extends the truncated image of the object in such a way that the barycenter of a x-ray attenuation line integral through the model of the object is the same as in a corresponding x-ray attenuation line integral through another model of the object.

It is believed to be advantageously, that the apparatus comprises a calculator, which calculates the barycenter by extrapolation, especially using polynomial extrapolation.

The object is also achieved according to the present invention by an apparatus, comprising an determiner, which determines the parameters of the model of the object iteratively using a cost function reflecting the similarity of the measured projection data and the virtual projection data of the model of the object.

According to another exemplary embodiment the apparatus comprises a constructor, which constructs the model of the object by using further data of the object.

It is believed to be advantageously, that an apparatus according to the present invention comprises a registration unit, which registers the data to the truncated image of the object.

It is also believed to be advantageously, that the data is an image from another CT scan.

### BRIEF DESCRIPTION OF THE DRAWINGS

The invention will now be explained in more detail by use of exemplary embodiments illustrated in the accompanying drawings in which:

FIG. 1 illustrates a block diagram showing the principle of Monte Carlo simulation based scatter correction,

FIG. 2 shows that with the full object representation, scattered radiation can be correctly simulated,

FIG. 3 illustrates errors introduced in the simulation due to missing object data outside the reconstructed field of view,

FIG. 4 shows the adaptation of model parameters to measured projection data,

FIG. 5. illustrates the use of a model for extending the field of view,

FIG. 6 shows the measured and reconstructed volume,

FIG. 7 illustrates the volume representation from external data source,

FIG. 8 shows the constructed model using registered external data set,

FIG. 9 shows the measured projection as well as the forward-projection of the reconstruction in the limited field of view,

FIG. 10 shows the extension of the truncated image along each ray with the water-equivalent of the difference,

FIG. 11 illustrates the barycenter of each ray found from an adapted model of an object,

FIG. 12 shows the extension of the truncated image using the barycenter found from an adapted model of an object.

FIG. 13 shows a flow-chart of an apparatus according to claim 12,

FIG. 14 shows a computer according to claim 11.

### DETAILED DESCRIPTION OF THE EMBODIMENTS

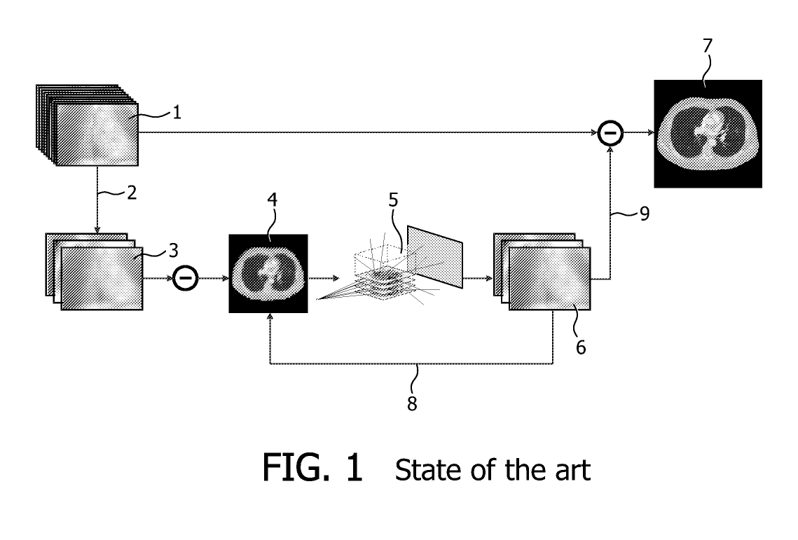

FIG. 1 shows the principle of the Monte Carlo simulation based scatter correction. Firstly, there is a full projection data set 1. This full projection data set is subsampled 2 in a coarse projection data set 3, which leads to a fast, coarse reconstruction 4. Then the Monte Carlo scatter simulation procedure is applied 5, which results in a coarse scatter data set 6. These last three steps can be repeated by iteration in order to improve accuracy. The result thereof is upsampled 9 and subtracted from the original full projection data set 1, which leads to a final reconstruction 7. This principle of Monte Carlo simulation based scatter correction is state of the art.

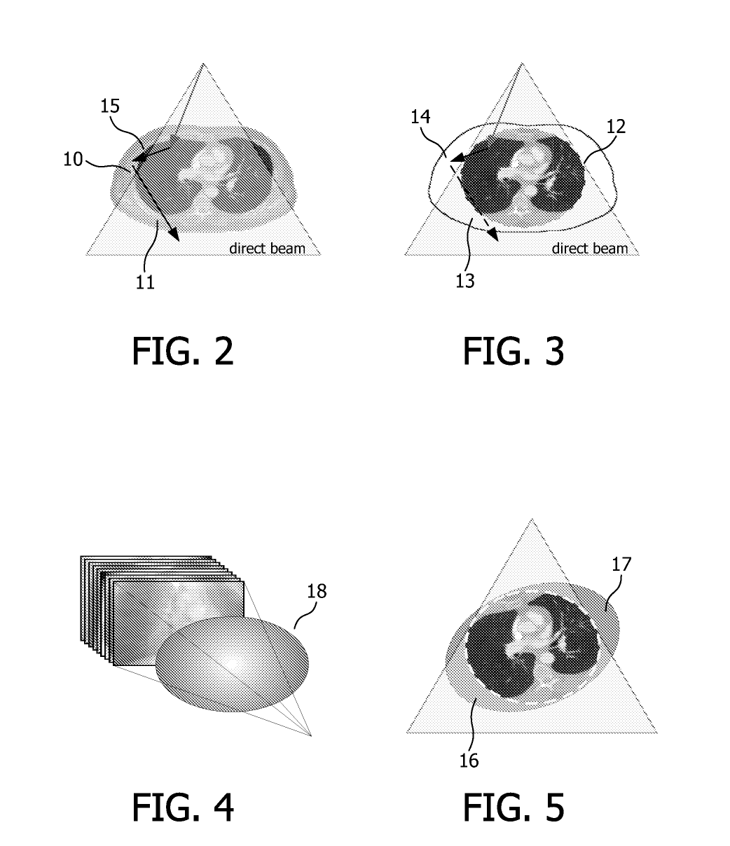

FIGS. 2 and 3 show the main error sources introduced in the Monte Carlo simulations in case the X-ray projections of the object are at least partially truncated, where only a truncated image of the object with a limited field of view can be reconstructed. First, regions missing prior and after the field of view with respect to the main beam direction do not contribute to the attenuation of the simulated rays which will introduce large errors due to the exponential decay law. Second, regions missing laterally, with respect to the beam direction, outside the field of view, do not contribute in further deflecting photons originating from scattering events in the directly irradidated portion of the object.

FIG. 2 shows that with the full object representation, scattered radiation can be correctly simulated. FIG. 2 shows especially a scattered ray 15 and the beam geometry correctly modelled 10 and 11.

FIG. 3 illustrates the errors introduced in the simulation due to missing object data outside the reconstructed field of view, whereas the reconstructed area with small field of view 12, a missing scattered radiation due to missing material 14 and missing attenuating material 13 is shown.

FIGS. 4 and 5 show a simple method to perform the required extension of the truncated image by using an object model 18. The parameters of the object model 18 can be iteratively determined using a cost function reflecting the similarity of the measured projection data and the virtual projection data of the model of the object 18. The virtual projection data can be computed at each iteration using the imaging geometry and the model parameters found at each iteration.

FIG. 4 shows especially the model after adaptation to measured projection data.

FIG. 5 shows the use of a model for extension 16, 17 of the truncated image. Once the model parameters are found the parametric object representation is transferred to a voxelized representation and both data sets, i.e. the reconstructed data inside the field of view of the imaging system and the voxelized representation of the object model, are merged. Inside the field of view of the imaging system the reconstructed data is used, outside the field of view the voxelized representation of the object model is used.

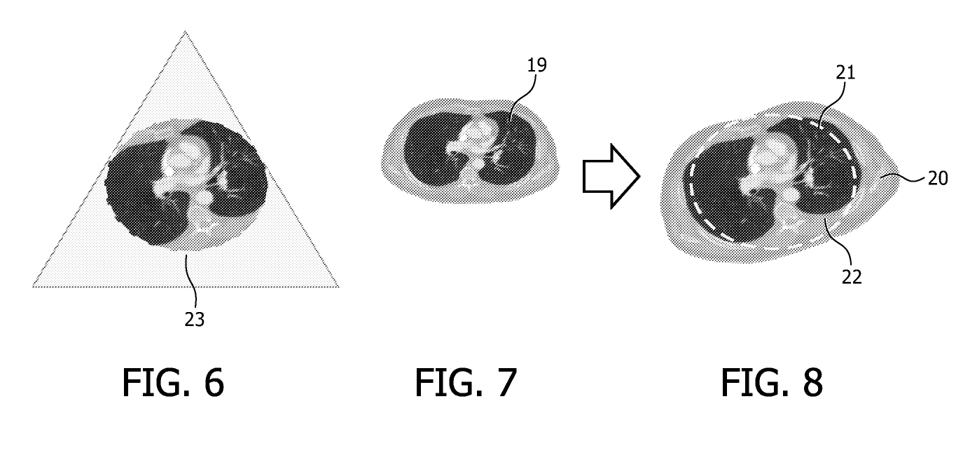

FIG. 6 shows the measured and reconstructed truncated image 23. In case a complete object representation of the object volume is available from other data sources, e.g. a diagnostic CT scan or a previous scan with a sufficiently large field of view, the required extension of the truncated image can be performed by registering the external data to the reconstructed small field of view. FIG. 7 shows a volume representation 19 from external data source, e.g. CT. FIG. 8 is the result of the registration. After registration, all voxels outside the small field of view are replaced by the registered object representation from the external data source. FIG. 8 shows the addition of the small field of view 22 with the external data 20. The border between these two areas is depicted by a discontinuous line 21.

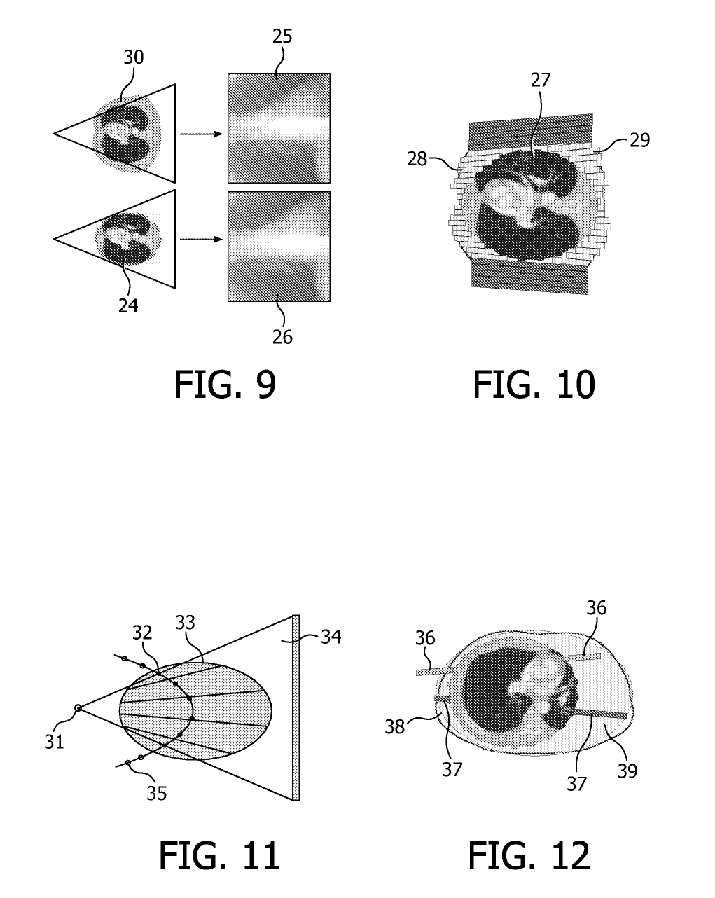

FIG. 9 shows the measured object 30 as well as the reconstructed truncated image 24, which lead to projections 25 and 26. FIG. 10 shows the result of comparing both projections 25 and 26, whereas the truncated image is extended along each ray with the water-equivalent of the difference. The reconstructed small field of view of the object is used in order to calculate forward projections corresponding to the geometry used for the measured projection data by means of voxelized ray casting. The difference of the measured projection and the forward projection of the small field of view constitutes a lacking portion of the line integral of each ray. This lacking portion of the line integral is then converted to the equivalent length of water and placed symmetrically in two portions prior 28 and after 29 the small field of view 27. For each projection direction, i.e. for each view position of the focus-detector system, a new extended model shall be computed. The rationale for this is that using this method the extended model in each view correctly reflects the measured line integrals. This property is most important for the correctness of the Monte Carlo simulations, because it assures that the self-attenuation of the scattered radiation in the main propagation direction is correctly taken into account. A slight shift of the material distribution towards the focus or towards the detector element—which cannot be prevented with this method—does not substantially alter the beam attenuation and is therefore less crucial. Extension of the truncated image outside the area covered by the respective projection direction is also less crucial, because these regions are only responsible for second order scattering effects and have therefore also only a minor impact on the correctness of the Monte Carlo scatter simulations. Extension of the truncated image in these regions may therefore be based on repeating the extension used for the closest ray within the area covered by the respective projection.

A further embodiment is suggested as follows: first a model of the object is adapted to the full set of projection data. Then for each ray the barycenter of the ray portion within the model is computed. During the voxelized ray casting of the reconstructed small field of view, in addition to the line integral the barycenter of the ray portion within the small field of view is computed. Finally the field of view extension of each ray, given by the water equivalent length of the difference of the measured line integral and the line integral found by the voxelized ray casting within the small field of view, is splitted into two portions prior 38 and after 39 the small field of view. This is done in such a way that the position of the barycenter of the composed extended ray and the corresponding ray in the adapted model of the object coincide. Barycenter points required for rays not crossing the model of the object may be computed by extrapolation, e.g. using polynominal extension. FIG. 11 illustrates the focal spot 31, the barycenter 32 of each ray, the points outside the model which may be found by extrapolation 35, as well as the model of the object 33 and the detector 34. FIG. 12 shows the suboptimal extension 36, if the symmetry assumption is not met. There is also the result of the above mentioned embodiment according the invention with the largely improved extension 37 when using the barycenter.

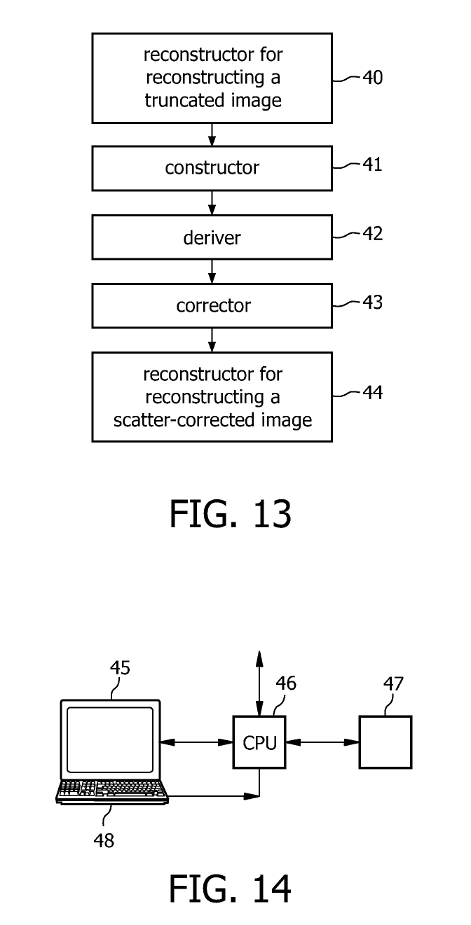

FIG. 13 shows a flow-chart of an apparatus for eliminating scatter artefacts that corrupt an image of an object using computed tomography, wherein X-ray projections of the object are at least partially truncated, whereas there is:

a reconstructor 40 for reconstructing a truncated image of the object with a limited field of view from the projections;
a constructor 41 for constructing a model of the object in an extended field of view using the truncated image of the object;
a deriver 42 for deriving a scatter estimate by means of Monte-Carlo simulation using the model of object;
a corrector 43 for correcting a projection of the object for X-ray scatter based on the scatter estimate;
a reconstructor 44 for reconstructing a scatter-corrected image using the corrected projections.

The invention relates also to a computer program, which may be stored on a record carrier as defined in claim 11. FIG. 14 shows the computer 48 with the display 45 in which a CPU 46 is working, which is connected with other input/output elements such as 47.

The proposed techniques are e.g. intended for flat-detector based cone-beam CT systems, such as used with C-arm geometry in current X-ray products. Furthermore, the techniques can also be used for diagnostic CT applications in case of occurring truncations (such as for obese patients).

It is especially described a method, a computer program as well as a corresponding apparatus for eliminating scatter artefacts that corrupt an image of an object using computed tomography, wherein X-ray projections of the object are at least partially truncated, whereas the method comprises the steps of: reconstructing a truncated image of the object with a limited field of view from the projections; constructing a model of the object in an extended field of view using the truncated image of the object; deriving a scatter estimate by means of Monte-Carlo simulation using the model of object; correcting a projection of the object for X-ray scatter based on the scatter estimate; reconstructing a scatter-corrected image using the corrected projections.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the internet or other wired or wireless telecommunication systems. Any reference signs in the claims should not be construed as limiting the scope.

1. Method for eliminating scatter artefacts that corrupt an image of an object using computed tomography, wherein X-ray projections of the object are at least partially truncated, comprising the steps of:
reconstructing a truncated image of the object with a limited field of view from the projections;
constructing a model of the object in an extended field of view using the truncated image of the object;
deriving a scatter estimate by means of Monte-Carlo simulation using the model of object;
correcting a projection of the object for X-ray scatter based on the scatter estimate;
reconstructing a scatter-corrected image using the corrected projections.

2. Method according to claim 1, whereas the model of the object is constructed by:
calculating a forward projection of the truncated image of the object according to the geometry of a measured projection;
calculating the difference between the forward projection of the truncated image of the object and the measured projection;
extending the truncated image of the object along each x-ray in two portions prior and after the limited field of view with a material accounting for the difference.

3. Method according to claim 2, wherein the truncated image is extended along each X-ray symmetrically prior and after the limited field of view.

4. Method according to claim 2, wherein the material is equivalent or similar to water.

5. Method according to claim 2, whereas the truncated image of the object is extended in such a way that the barycenter of a X-ray through the model of the object is the same as in a corresponding X-ray through another model of the object.

6. Method according to claim 5, whereas the barycenter is calculated by extrapolation, especially using polynomial extrapolation.

7. Method according to claim 1, whereas the parameters of the model of the object are iteratively determined using a cost function reflecting the similarity of the measured projection data and the virtual projection data of the model of the object.

8. Method according to claim 1, whereas the model of the object is constructed by using further data of the object.

9. Method according to claim 8, wherein the data is registered to the truncated image of the object.

10. Method according to claim 9, wherein the data is an image from another CT scan.

11. Computer program comprising program code means for causing a computer to carry out the steps of the method according to claim 1 when the computer program is executed on a computer.

12. Apparatus for eliminating scatter artefacts that corrupt an image of an object using computed tomography, wherein X-ray projections of the object are at least partially truncated, comprising:
a reconstructor for reconstructing a truncated image of the object with a limited field of view from the projections;
a constructor for constructing a model of the object in an extended field of view using the truncated image of the object;
a deriver for deriving a scatter estimate by means of Monte-Carlo simulation using the model of object;
a corrector for correcting a projection of the object for X-ray scatter based on the scatter estimate;
a reconstructor for reconstructing a scatter-corrected image using the corrected projections.

13. Apparatus according to claim 12, whereas the apparatus is adapted to construct the model of the object by:
a calculator for calculating a forward projection of the truncated image of the object according to the geometry of a measured projection;
a calculator for calculating the difference between the forward projection of the truncated image of the object and the measured projection;
an extender for extending the truncated image of the object along each x-ray in two portions prior and after the limited field of view with a material accounting for the difference.

14. Apparatus according to claim 13, whereas the apparatus is adapted to extend the truncated image along each X-ray symmetrically prior and after the limited field of view.

15. Apparatus according to claim 13, wherein the material is equivalent or similar to water.

16. Apparatus according to claim 13, comprising:
an extender, which extends the truncated image of the object in such a way that the barycenter of a x-ray through the model of the object is the same as in a corresponding x-ray through another model of the object.

17. Apparatus according to claim 16, comprising a calculator, which calculates the barycenter by extrapolation, especially using polynomial extrapolation.

18. Apparatus according to claim 12, comprising a determiner, which determines the parameters of the model of the object iteratively using a cost function reflecting the similarity of the measured projection data and the virtual projection data of the model of the object.

19. Apparatus according to claim 12, comprising a constructor, which constructs the model of the object by using further data of the object.

20. Apparatus according to claim 19, comprising a registration unit, which registers the data to the truncated image of the object.

21. Apparatus according to claim 20, wherein the data is an image from another CT scan.
